(19) United States
(12) Patent Application Publication
(10) Pub. No.: US 2012/0287390 A1
(43) Pub. Date: Nov. 15, 2012

(54) Liquid Crystal Alignment Agent, Liquid Crystal Alignment Film Manufactured Using the Same, and Liquid Crystal Display Device Including the Liquid Crystal Alignment Film

(75) Inventors: Eun-Ha KIM, Uiwang-si (KR); Jae-Deuk YANG, Uiwang-si (KR); Yong-Sik YOO, Uiwang-si (KR); Myoung-Youp SHIN, Uiwang-si (KR); Guk-Pyo JO, Uiwang-si (KR)

(73) Assignee: CHEIL INDUSTRIES INC., Gumi-si (KR)

(21) Appl. No.: 13/353,559

(22) Filed: Jan. 19, 2012

(30) Foreign Application Priority Data
May 11, 2011 (KR) 10-2011-0044049

(51) Int. Cl. G02F 1/1337; C08G 73/10; C08G 73/12

(52) U.S. Cl. 349/127; 528/184; 525/421

(57) ABSTRACT

Disclosed is a liquid crystal alignment agent that includes a polymer comprising polyamic acid including a structural unit represented by the following Chemical Formula 1, polyimide including a structural unit represented by the following Chemical Formula 2, or a combination thereof.

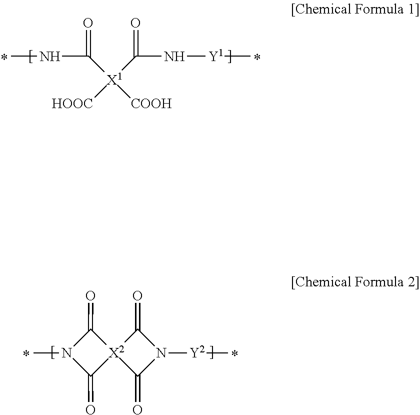

In Chemical Formulas 1 and 2, each X¹, X², Y¹ and Y² is the same as in the detailed description.

### CROSS-REFERENCE TO RELATED APPLICATION

This application claims priority to and the benefit of Korean Patent Application No. 10-2011-0044049 filed in the Korean Intellectual Property Office on May 11, 2011, the entire disclosure of which is incorporated herein by reference.

### FIELD OF THE INVENTION

This disclosure relates to a liquid crystal alignment agent, a liquid crystal alignment film manufactured using the same, and a liquid crystal display including the liquid crystal alignment film.

### BACKGROUND OF THE INVENTION

A liquid crystal display (LCD) includes a liquid crystal alignment film, and the liquid crystal alignment film is mainly made of polymer materials. The liquid crystal alignment film plays a role of a director in aligning liquid crystal molecules. When the liquid crystal molecules are moved by the influence of an electric field to display an image, the liquid crystal alignment film allows them to be oriented in a predetermined direction. Generally, it is necessary to uniformly align the liquid crystal molecules in order to provide uniform brightness and a high contrast ratio to the LCD.

There is an increased demand for high quality LCDs. In addition, since LCDs are rapidly becoming larger, there is an increasing requirement for a highly productive liquid crystal alignment film. Accordingly, there is a need for a liquid crystal alignment film having a low defect rate in the LCD manufacturing process, excellent electro-optical characteristics, high reliability, and high performance that widely satisfies different characteristics for variously-developing LCDs. Liquid crystal alignment film materials are also required to have excellent optical stability and thermal stability and no after-image in order to be substantially applied to a liquid crystal display.

### SUMMARY OF THE INVENTION

One embodiment provides a liquid crystal alignment agent that may be aligned at small or low energy levels; maintain excellent vertical alignment strength; provide excellent texture; enhance photo-reactivity to improve sensitivity; and prevent the generation of luminance difference during operation.

Another embodiment provides a liquid crystal alignment film manufactured using the liquid crystal alignment agent.

Yet another embodiment provides a liquid crystal display including the liquid crystal alignment film.

According to one embodiment, a liquid crystal alignment agent includes a polymer including a polyamic acid including a repeating unit represented by the following Chemical Formula 1, polyimide including a repeating unit represented by the following Chemical Formula 2, or a combination thereof.

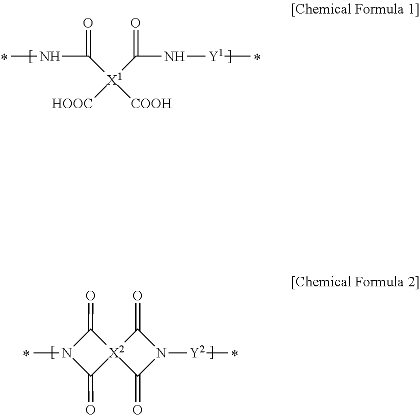

In Chemical Formulas 1 and 2,

X¹ and X² are the same or different and are each independently a tetravalent organic group derived from alicyclic acid dianhydride or aromatic acid dianhydride,

Y¹ and Y² are the same or different and are each independently a divalent organic group derived from diamine, wherein the diamine includes a diamine represented by the following Chemical Formula 3 and a diamine represented by the following Chemical Formula 4.

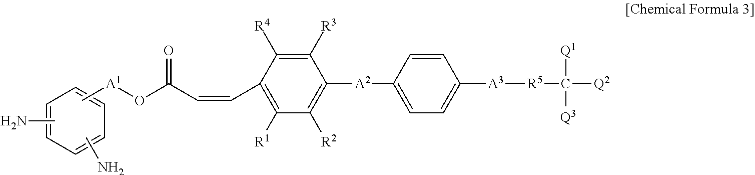

In Chemical Formula 3,

A¹ is a single bond or C1 to C2 alkylene,

A² is substituted or unsubstituted C1 to C30 alkylene or C1 to C30 alkylene wherein at least one —CH₂— group thereof is independently replaced by —O—, —O(O)C—, —C(O)O—, —OC(O)O—, —N(H)C(O)—, —C(O)N(H)—, or —C(O)—,

A³ is a single bond, O, SO₂, or C(R¹⁰³)(R¹⁰⁴ wherein R¹⁰³ and R¹⁰⁴ are the same or different and are independently hydrogen or substituted or unsubstituted C1 to C6 alkyl,

R¹ to R⁴ are the same or different and are independently hydrogen, substituted or unsubstituted C1 to C30 alkyl, substituted or unsubstituted C6 to C30 aryl, or substituted or unsubstituted C2 to C30 heteroaryl,

R⁵ is substituted or unsubstituted C1 to C30 alkylene or C1 to C30 alkylene wherein at least one —CH₂— group thereof is independently replaced by —C(O)—, —C(O)O—, —N(W)—, —N(W)C(O)—, —C(O)N(W)—, or —CH═CH—, wherein W is hydrogen or C1 to C10 alkyl, with the proviso that oxygen atoms are not directly linked to one other, and

Q¹, Q² and Q³ is each independently hydrogen or halogen.

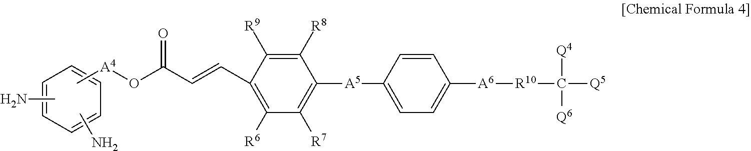

In Chemical Formula 4,

A⁴ is a single bond or C1 to C2 alkylene,

A⁵ is substituted or unsubstituted C1 to C30 alkylene or C1 to C30 alkylene wherein at least one —CH₂— group thereof is independently replaced by —O—, —OC(O)—, —C(O)O—, —OC(O)O—, —N(H)C(O)—, —C(O)N(H)—, or —C(O)—,

A⁶ is a single bond, O, SO₂ or C(R¹⁰⁵)(R¹⁰⁶), wherein R¹⁰⁵ and R¹⁰⁶ are the same or different and are independently hydrogen or substituted or unsubstituted C1 to C6 alkyl,

R⁶ to R⁹ are the same or different and are independently hydrogen, substituted or unsubstituted C1 to C30 alkyl, substituted or unsubstituted C6 to C30 aryl, or substituted or unsubstituted C2 to C30 heteroaryl,

R¹⁰ is substituted or unsubstituted C1 to C30 alkylene or C1 to C30 alkylene wherein at least one —CH₂— group thereof is independently replaced by —C(O)—, —C(O)O—, —N(Z′)—, —N(Z′)C(O)—, —C(O)N(Z′)—, or —CH═CH—, wherein Z′ is hydrogen or C1 to C10 alkyl, with the proviso that oxygen atoms are not directly linked to one other, and

Q⁴, Q⁵ and Q⁶ is each independently hydrogen or halogen.

The diamine may include about 10 mol % to about 90 mol % of the diamine represented by the above Chemical Formula 3 and about 10 mol % to about 90 mol % of the diamine represented by the above Chemical Formula 4, based on the total amount of diamine.

The diamine represented by the above Chemical Formula 3 may include for example, the diamine represented by the following Chemical Formula 5.

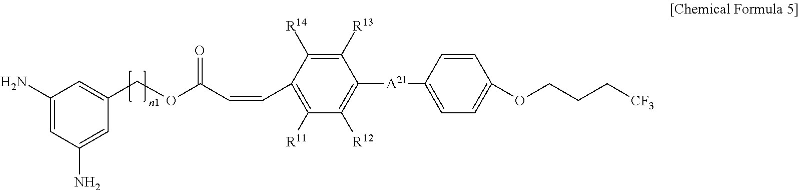

In Chemical Formula 5,

A²¹ is —O—, —OC(O)—, or —C(O)O,

R¹¹ to R¹⁴ are each independently hydrogen or substituted or unsubstituted C1 to C10 alkyl, and

n1 is an integer ranging from 0 to 2.

The diamine represented by the above Chemical Formula 4 may include for example, the diamine represented by the following Chemical Formula 6.

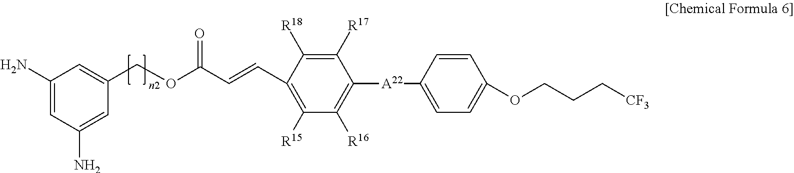

In Chemical Formula 6,

A²² is —O—, —OC(O)—, or —C(O)O—,

R¹⁵ to R¹⁸ are each independently hydrogen or substituted or unsubstituted C1 to C10 alkyl, and

n2 is an integer ranging from 0 to 2.

The polyamic acid and the polyimide may each independently have a weight average molecular weight of about 50,000 to about 500,000.

When the liquid crystal alignment agent includes both the polyamic acid and the polyimide, the liquid crystal alignment agent may include the polyamic acid and the polyimide at a weight ratio of about 1:99 to about 50:50.

The liquid crystal alignment agent may have about 1 wt % to about 30 wt % of a solid content.

According to another embodiment, a liquid crystal alignment film manufactured by applying the liquid crystal alignment agent to a substrate is provided.

According to yet another embodiment, a liquid crystal display including the liquid crystal alignment film is provided.

The liquid crystal alignment agent may be aligned using low or small amounts of energy and can provide excellent texture and sensitivity.

### BRIEF DESCRIPTION OF THE DRAWINGS

FIG. 1 is a UV absorption spectrum measured for polyimide resins obtained from the Examples and Comparative Examples.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements. As used herein, when a specific definition is not otherwise provided, the term “substituted” may refer to one substituted with a substituent including halogen (F, Br, Cl or I), hydroxy, nitro, cyano, amino (NH₂, NH(R¹⁰⁰) or N(R¹⁰¹)(R¹⁰²), wherein R¹⁰⁰, R¹⁰¹, and R¹⁰² are the same or different and are each independently C1 to C10 alkyl), amidino, hydrazine, hydrazone, carboxyl, substituted or unsubstituted C1 to C30 alkyl, substituted or unsubstituted C1 to C30 haloalkyl, substituted or unsubstituted C1 to C30 alkoxy, substituted or unsubstituted C3 to C30 alicyclic organic group, substituted or unsubstituted C5 to C30 aryl, substituted or unsubstituted C2 to C30 alkenyl, substituted or unsubstituted C2 to C30 alkynyl, substituted or unsubstituted C2 to C30 heteroaryl, substituted or unsubstituted C2 to C30 heterocycloalkyl, or a combination thereof, instead of at least one of hydrogen of a functional group.

As used herein, when a specific definition is not otherwise provided, the term “alkyl” may refer to C1 to C30 alkyl, for example C1 to C20 alkyl, the term “cycloalkyl” may refer to C3 to C30 cycloalkyl, for example C3 to C20 cycloalkyl, the term “heterocycloalkyl” may refer to C2 to C30 heterocycloalkyl, for example C2 to C20 heterocycloalkyl, the term “alkylene” may refer to C1 to C30 alkylene, for example C1 to C20 alkylene, the term “alkoxy” may refer to C1 to C30 alkoxy, for example C1 to C20 alkoxy, the term “cycloalkylene” may refer to C3 to C30 cycloalkylene, for example C3 to C20 cycloalkylene, the term “heterocycloalkylene” may refer to C2 to C30 heterocycloalkylene, for example C2 to C20 heterocycloalkylene, the term “aryl” may refer to C5 to C30 aryl, for example C6 to C20 aryl, the term “heteroaryl” may refer to C2 to C30 heteroaryl, for example C2 to C18 heteroaryl, the term “arylene” may refer to C5 to C30 arylene, for example C6 to C20 arylene, the term “heteroarylene” may refer to C2 to C30 heteroarylene, for example C2 to C20 heteroarylene, the term “alkylaryl” may refer to C7 to C30 alkylaryl, for example C7 to C20 alkylaryl, and the term “halogen” may refer to F, Cl, Br, or I.

As used herein, when a specific definition is not otherwise provided, the terms heterocycloalkyl, heterocycloalkylene, heteroaryl, and heteroarylene may independently refer to cycloalkyl, cycloalkylene, aryl, and arylene including 1 to 3 heteroatoms including N, O, S, Si, P or a combination thereof in place of one or more carbon ring atoms.

As used herein, when a specific definition is not otherwise provided, the term “aliphatic” may refer to C1 to C30 alkyl, C2 to C30 alkenyl, C2 to C30 alkynyl, C1 to C30 alkylene, C2 to C30 alkenylene, or C2 to C30 alkynylene, for example C1 to C20 alkyl, C2 to C20 alkenyl, C2 to C20 alkynyl, C1 to C20 alkylene, C2 to C20 alkenylene, or C2 to C20 alkynylene, the term “alicyclic” may refer to C3 to C30 cycloalkyl, C3 to C30 cycloalkenyl, C3 to C30 cycloalkynyl, C3 to C30 cycloalkylene, C3 to C30 cycloalkenylene, or C3 to C30 cycloalkenylene, for example C3 to C20 cycloalkyl, C3 to C20 cycloalkenyl, C3 to C20 cycloalkynyl, C3 to C20 cycloalkylene, C3 to C20 cycloalkenylene, or C3 to C20 cycloalkenylene, and the term “aromatic” may refer to C5 to C30 aryl, C2 to C30 heteroaryl, C5 to C30 arylene, or C2 to C30 heteroarylene, for example C6 to C16 aryl, C2 to C16 heteroaryl, C6 to C16 arylene, or C2 to C16 heteroarylene.

As used herein, when a specific definition is not otherwise provided, the term “combination” may refer to mixture or copolymerization; in case of an alicyclic organic group and an aromatic organic group, a fused ring of two or more rings, or two or more rings linked by a single bond, O, S, C(═O), CH(OH), S(═O), S(═O)₂, Si(CH₃)₂, (CH₂)ₚ (wherein, 1≦p≦2), (CF)_{2q} (wherein, 1≦q≦2), C(CH₃)₂, C(CF₃)₂, C(CH₃)(CF₃), or C(═O)NH. As used herein, “copolymerization” may refer to block copolymerization or to random copolymerization, and “copolymer” may refer to a block copolymer or to a random copolymer.

“*” denotes a position linked to the same or different atom or Chemical Formula.

The liquid crystal alignment agent according to one embodiment includes a polymer comprising polyamic acid including a structural unit represented by the following Chemical Formula 1, polyimide including a structural unit represented by the following Chemical Formula 2, or a combination thereof.

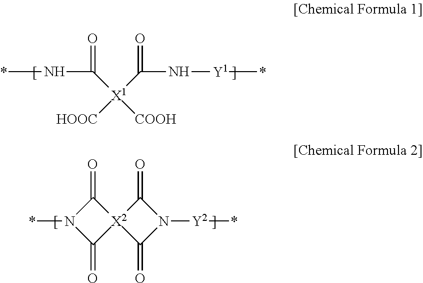

In Chemical Formulas 1 and 2,

X¹ and X² are the same or different and are each independently a tetravalent organic group derived from alicyclic acid dianhydride or aromatic acid dianhydride,

X¹ may be the same or different in each repeating unit, and X² may be the same or different in each repeating unit.

Y¹ and Y² are the same or different and are each independently a divalent organic group derived from diamine, wherein the diamine includes a diamine represented by the following Chemical Formula 3 and a diamine represented by the following Chemical Formula 4. Each of the polyamic acid and the polyimide may include a divalent organic group derived from diamine represented by the following Chemical Formula 3 and a divalent organic group derived from diamine represented by the following Chemical Formula 4.

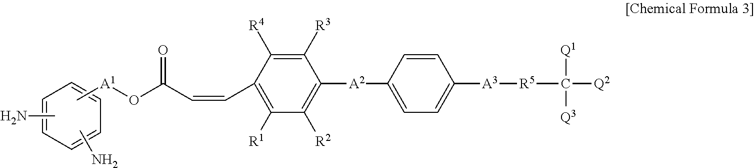

In Chemical Formula 3,

A¹ is a single bond or C1 to C2 alkylene,

A² is substituted or unsubstituted C1 to C30 alkylene or C1 to C30 alkylene wherein at least one —CH₂— group thereof is independently replaced by —O—, —O(O)C—, —C(O)O—, —OC(O)O—, —N(H)C(O)—, —C(O)N(H)—, or —C(O)—,

A³ is a single bond, O, SO₂, or C(R¹⁰³)(R¹⁰⁴), wherein R¹⁰³ and R¹⁰⁴ are the same or different and are independently hydrogen or substituted or unsubstituted C1 to C6 alkyl,

R¹ to R⁴ are the same or different and are independently hydrogen, substituted or unsubstituted C1 to C30 alkyl, substituted or unsubstituted C6 to C30 aryl, or substituted or unsubstituted C2 to C30 heteroaryl,

R⁵ is substituted or unsubstituted C1 to C30 alkylene or C1 to C30 alkylene wherein at least one —CH₂— group thereof is independently replaced by —C(O)—, —C(O)O—, —N(W)—, —N(W)C(O)—, —C(O)N(W)— or —CH═CH—, wherein W is hydrogen or C1 to C10 alkyl, with the proviso that oxygen atoms are not directly linked to one other (that is, O in R⁵ does not form —O—O— bonding within R⁵ and with O adjacent to R⁵), and

Q¹, Q² and Q³ is each independently hydrogen or halogen.

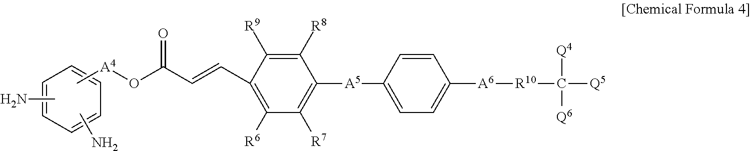

In Chemical Formula 4,

A⁴ is a single bond or C1 to C2 alkylene,

A⁵ is substituted or unsubstituted C1 to C30 alkylene or C1 to C30 alkylene wherein at least one —CH₂— group thereof is independently replaced by —O—, —OC(O)—, —C(O)O—, —OC(O)O—, —N(H)C(O)—, —C(O)N(H)—, or —C(O)—,

A⁶ is a single bond, O, SO₂ or C(R¹⁰⁵)(R¹⁰⁶), wherein R¹⁰⁵ and R¹⁰⁶ are the same or different and are independently hydrogen or substituted or unsubstituted C1 to C6 alkyl,

R⁶ to R⁹ are the same or different and are independently hydrogen, substituted or unsubstituted C1 to C30 alkyl group, substituted or unsubstituted C6 to C30 aryl, or substituted or unsubstituted C2 to C30 heteroaryl,

R¹⁰ is substituted or unsubstituted C1 to C30 alkylene or C1 to C30 alkylene wherein at least one —CH₂— group thereof is independently replaced by —C(O)—, —C(O)O—, —N(Z′)—, —N(Z′)C(O)—, —C(O)N(Z′)—, or —CH═CH—, wherein Z′ is hydrogen or C1 to C10 alkyl, with the proviso that oxygen atoms are not directly linked to one other, and

Q⁴, Q⁵ and Q⁶ is each independently hydrogen or halogen.

As indicated by the carbon double bond included in the compound represented by Chemical Formula 3 and the carbon double bond included in the compound represented by Chemical Formula 4, the compounds represented by Chemical Formulae 3 and 4 are stereoisomers having a spatially different structure. The compound represented by Chemical Formula 3 has a cis spatial structure; and the compound represented by Chemical Formula 4 has a trans spatial structure. In the structural formulas of above Chemical Formula 3 and Chemical Formula 4, two linking groups linked to the carbon double bonds are illustrated to be connected in one direction in Chemical Formula 3; and they are shown to be connected in the different direction in Chemical Formula 4. Thus, the compounds represented by Chemical Formulae 3 and 4 have a cis spatial structure and a trans spatial structure, respectively, as in the manner of illustrating a stereoisomer.

For convenience, the term ‘cis’ refers to the case of having a spatial structure of a carbon double bond shown in Chemical Formula 3; and the term ‘trans’ refers to the case of having a spatial structure of a carbon double bond shown in Chemical Formula 4.

The liquid crystal alignment agent includes a polyamic acid including both an organic group derived from cis diamine and an organic group derived from trans diamine and/or a polyimide including both an organic group derived from cis diamine and an organic group derived from trans diamine. However, the organic group derived from cis diamine may not have the same molecular formula as in the organic group derived from trans diamine.

The liquid crystal alignment agent can improve photo-reaction rate, so it may be aligned at low or small energy levels; maintain excellent vertical alignment strength; provide excellent texture; enhance photo-reactivity; improve sensitivity; and prevent the generation of luminance difference during operation.

The diamine may include about 10 mol % to about 90 mol % of the diamine represented by the above Chemical Formula 3 and about 10 mol % to about 90 mol % of the diamine represented by the above Chemical Formula 4, based on the total amount of diamine.

In some embodiments, the diamine may include the diamine represented by Chemical Formula 3 in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 mol %. Further, according to some embodiments of the present invention, the amount of the diamine represented by Chemical Formula 3 can be in a range from about any of the foregoing amounts to about any other of the foregoing amounts.

In some embodiments, the diamine may include the diamine represented by Chemical Formula 4 in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 mol %. Further, according to some embodiments of the present invention, the amount of the diamine represented by Chemical Formula 4 can be in a range from about any of the foregoing amounts to about any other of the foregoing amounts.

In exemplary embodiments, the amine may include about 20 mol % to about 50 mol % of the diamine represented by the above Chemical Formula 3 and about 50 mol % to about 80 mol % of the diamine represented by the above Chemical Formula 4.

When the diamine includes a diamine represented by Chemical Formula 3 and a diamine represented by Chemical Formula 4 in amounts within the above range, the photo-reaction rate can effectively be improved to provide uniform reactivity to the whole layer to provide an alignment layer with excellent alignment property and reliability.

The diamine represented by the above Chemical Formula 3 may be, for example, diamine represented by the following Chemical Formula 5, but is not limited thereto.

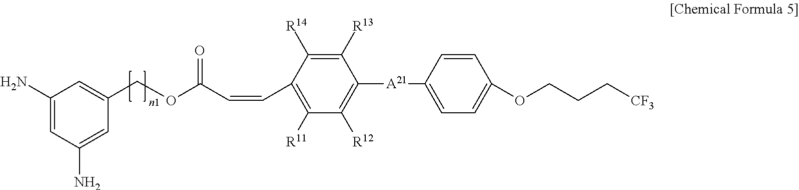

In Chemical Formula 5,

A²¹ is —O—, —OC(O)—, or —C(O)O—,

R¹¹ to R¹⁴ are each independently hydrogen or substituted or unsubstituted C1 to C10 alkyl, and

n1 is an integer ranging from 0 to 2.

The diamine represented by the above Chemical Formula 4 may be, for example, diamine represented by the following Chemical Formula 6, but is not limited thereto.

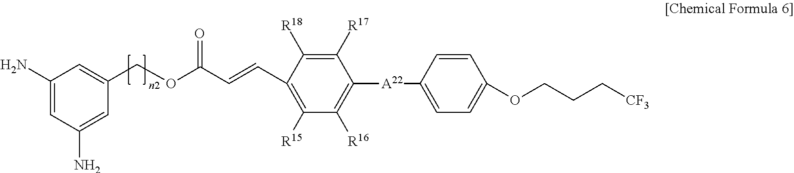

In Chemical Formula 6,

A²² is —O—, —OC(O)—, or —C(O)O—,

R¹⁵ to R¹⁸ are each independently hydrogen or substituted or unsubstituted C1 to C10 alkyl, and

n2 is an integer ranging from 0 to 2. The liquid crystal alignment agent may further include a solvent, or other additives besides the polymer. Hereinafter, the components of the liquid crystal alignment agent are described in detail.

Polymer

The polymer may be a photopolymer including polyamic acid including the structural unit represented by the above Chemical Formula 1, polyimide including the structural unit represented by the above Chemical Formula 2, or a combination thereof.

The polymers are anisotropically reacted in, for example, a photo isomerization, a photo cross-linkage or the like due to the polarized irradiation. Thereby, the polymers can provide anisotropy on the polymer surface to induce the molecular alignment of liquid crystal in one direction.

The polyamic acid including a structural unit represented by Chemical Formula 1 may be synthesized from acid dianhydride, the diamine represented by the above Chemical Formula 3, and the diamine represented by the above Chemical Formula 4. The method of preparing the polyamic acid by copolymerizing the acid dianhydride and the diamine represented by the above Chemical Formula 3 and the diamine represented by the above Chemical Formula 4 may include any methods known for synthesizing polyamic acid without limitation.

In addition, the polyimide including the structural unit represented by the above Chemical Formula 2 may be synthesized from acid dianhydride, the diamine represented by the above Chemical Formula 3, and the diamine represented by the above Chemical Formula 4. The acid dianhydride and the diamine represented by the above Chemical Formula 3 and the diamine represented by the above Chemical Formula 4 may be copolymerized and immunized to provide a polyimide according to methods known in the art, and the detailed description is omitted.

Examples of the acid dianhydride may include without limitation alicyclic acid dianhydride, aromatic acid dianhydride, and the like, and combinations thereof.

Examples of the alicyclic acid dianhydride may include without limitation 1,2,3,4-cyclobutanetetracarboxylic acid dianhydride (CBDA), 5-(2,5-dioxotetrahydropuryl)-3-methylcyclohexene-1,2-dicarboxylic acid anhydride (DOCDA), bicyclooctane-2,3,5,6-tetracarboxylic acid dianhydride (BODA), 1,2,3,4-cyclopentanetetracarboxylic acid dianhydride (CPDA), 1,2,4,5-cyclohexanetetracarboxylic acid dianhydride (CHDA), 1,2,4-tricarboxyl-3-methylcarbonyl cyclopentane dianhydride, 1,2,3,4-tetracarbonyl cyclopentane dianhydride, 4,10-dioxa-tricyclo[6.3.1.0^{2,7}]dodecane-3,5,9,11-tetraone, and the like, and combinations thereof.

Examples of the tetravalent organic group derived from the alicyclic acid dianhydride may include without limitation a functional group represented by one of the following Chemical Formulas 9 to 14, or a combination thereof.

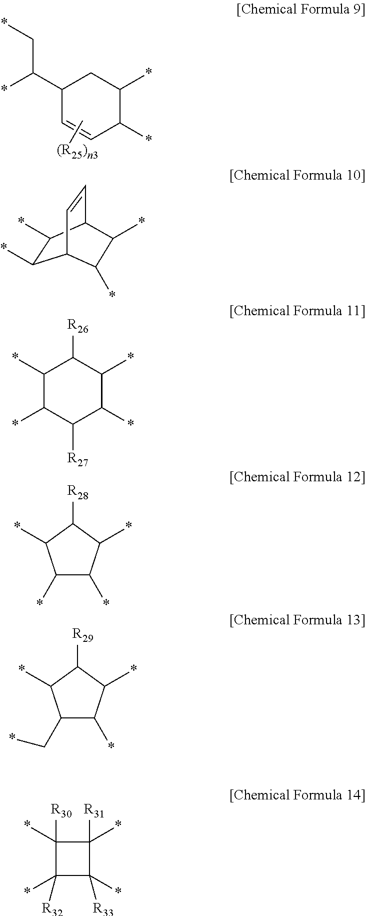

In Chemical Formulas 9 to 14,

R₂₅ is the same or different and is each independently substituted or unsubstituted alkyl, substituted or unsubstituted aryl, or substituted or unsubstituted heteroaryl,

n₃ is integer ranging from 0 to 3, and

R₂₆ to R₃₃ are the same or different and are each independently hydrogen, substituted or unsubstituted alkyl, substituted or unsubstituted aryl, or substituted or unsubstituted heteroaryl.

When n₃ is an integer of 2 or more, a plurality of R₂₅ may be the same or different.

Examples of the aromatic acid dianhydride may include without limitation pyromellitic acid dianhydride (PMDA), bisphthalic acid dianhydride (BPDA), oxydiphthalic acid dianhydride (ODPA), benzophenonetetracarboxylic acid dianhydride (BTDA), hexafluoroisoproylidene diphthalic acid dianhydride (6-FDA), and the like, and combinations thereof.

Examples of the tetravalent organic group derived from the aromatic acid dianhydride may include without limitation a functional group represented by the following Chemical Formula 15, a functional group represented by the following Chemical Formula 16, or a combination thereof.

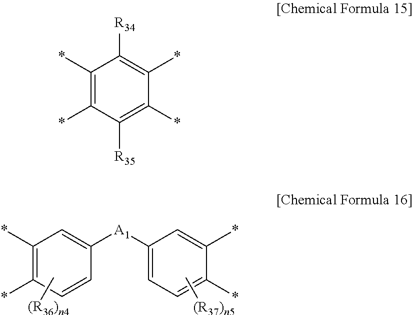

In Chemical Formulas 15 and 16,

R₃₄ and R₃₅ are the same or different and are each independently hydrogen, substituted or unsubstituted alkyl, substituted or unsubstituted aryl, or substituted or unsubstituted heteroaryl,

R₃₆ and R₃₇ are the same or different and are each independently substituted or unsubstituted alkyl, substituted or unsubstituted aryl, or substituted or unsubstituted heteroaryl,

n₄ and n₅ are each independently an integer ranging from 0 to 3, and

A₁ is a single bond, O, CO, substituted or unsubstituted C1 to C6 alkylene (e.g., C(CF₃)₂), substituted or unsubstituted C3 to C30 cycloalkylene, or substituted or unsubstituted C2 to C30 heterocycloalkylene.

When n₄ is an integer of 2 or more, a plurality of R₃₆ may be the same or different. When n₅ is an integer of 2 or more, a plurality of R₃₇ may be the same or different.

The polyamic acid and the polyimide may each independently have weight average molecular weights of about 50,000 to about 500,000. When the polyamic acid and the polyimide have a weight average molecular weight within the above range, they may effectively improve dissolubility, thermal stability, and chemical resistance and also may maintain appropriate viscosity, to provide an excellent printability and easily form a uniform layer.

When the liquid crystal alignment agent includes both the polyamic acid and the polyimide, the polyamic acid and the polyimide may be included at a weight ratio of about 1:99 to about 50:50, for example a weight ratio of about 10:90 to about 50:50.

In some embodiments, the combination of the polyamic acid and the polyimide may include the polyamic acid in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the polyamic acid can be in a range from about any of the foregoing amounts to about any other of the foregoing amounts.

In some embodiments, the combination of the polyamic acid and the polyimide may include the polyimide in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the polyimide can be in a range from about any of the foregoing amounts to about any other of the foregoing amounts.

Alignment stability may be improved when the polyamic acid and the polyimide are included in amounts within the above range.

The liquid crystal alignment agent may include the polymer in an amount of about 1 wt % to about 30 wt %, for example, about 3 wt % to about 20 wt % In some embodiments, the liquid crystal alignment agent may include the polymer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the polymer can be in a range from about any of the foregoing amounts to about any other of the foregoing amounts.

When the polymer is included in an amount within the above range, it may improve printability and liquid crystal alignment properties.

Solvent

The liquid crystal alignment agent according to one embodiment of the present invention includes a suitable solvent to dissolve the polymer. Thereby, the liquid crystal alignment agent may have excellent spreadability and adherence with a substrate.

Examples of solvents suitable for dissolving the polymer may include without limitation N-methyl-2-pyrrolidone; N,N-dimethyl acetamide; N,N-dimethyl formamide; dimethyl sulfoxide; γ-butyrolactone; tetrahydrofuran (THF); phenol-based solvents such as meta cresol, phenol, and halgenated phenols; and the like, and combinations thereof.

The solvent may further include 2-butyl cellosolve (2-BC) to improve printability. The solvent may include 2-butyl cellosolve in an amount of about 1 wt % to about 70 wt %, for example about 20 to about 60 wt %, based on the total amount of solvent including 2-butyl cellosolve.

In some embodiments, the solvent may include 2-butyl cellosolve in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50, 51, 52, 53, 54, 55, 56, 57, 58, 59, 60, 61, 62, 63, 64, 65, 66, 67, 68, 69, or 70 wt %. Further, according to some embodiments of the present invention, the amount of 2-butyl cellosolve can be in a range from about any of the foregoing amounts to about any other of the foregoing amounts.

When the solvent includes 2-butyl cellosolve in an amount within the above range, it may readily improve printability.

In addition, the solvent may further include a poor solvent. Examples of poor solvents include without limitation alcohols, ketones, esters, ethers, hydrocarbons, halgenated hydrocarbons, and the like, and combinations thereof. The poor solvent can be present in an appropriate ratio as long as the soluble polyimide polymer is not precipitated. The poor solvents may decrease the surface energy of liquid crystal alignment agent to improve spreadability and flatness during the coating process.

The liquid crystal alignment agent can include the poor solvent in an amount of about 1 wt % to about 90 wt %, for example about 1 wt % to about 70 wt %, based on the total amount of solvent including poor solvent. In some embodiments, the liquid crystal alignment agent can include the poor solvent in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the poor solvent can be in a range from about any of the foregoing amounts to about any other of the foregoing amounts.

Examples of the poor solvent may include without limitation methanol, ethanol, isopropanol, cyclohexanol, ethyleneglycol, propyleneglycol, 1,4-butanediol, triethyleneglycol, acetone, methylethylketone, cyclohexanone, methylacetate, ethylacetate, butylacetate, diethyloxalate, malonic acid ester, diethylether, ethyleneglycol monomethylether, ethyleneglycol dimethylether, ethyleneglycol monoethylether, ethyleneglycol phenylether, ethyleneglycol phenylmethylether, ethyleneglycol phenylethylether, diethyleneglycol dimethylether, diethyleneglycol ether, diethyleneglycol monomethylether, diethyleneglycol monoethylether, diethyleneglycol monomethylether acetate, diethyleneglycol monoethylether acetate, ethyleneglycol methylether acetate, ethyleneglycol ethylether acetate, 4-hydroxy-4-methyl-2-pentanone, 2-hydroxy ethyl propionate, 2-hydroxy-2-methyl ethyl propionate, ethoxy ethyl acetate, hydroxy ethyl acetate, 2-hydroxy-3-methyl methyl butanoate, 3-methoxy methyl propionate, 3-methoxy ethyl propionate, 3-ethoxy ethyl propionate, 3-ethoxy methyl propionate, methyl methoxy butanol, ethyl methoxy butanol, methyl ethoxy butanol, ethyl ethoxy butanol, tetrahydrofuran, dichloromethane, 1,2-dichloroethane, 1,4-dichlorobutane, trichloroethane, chlorobenzene, o-dichlorobenzene, hexane, heptane, octane, benzene, toluene, xylene, and the like, and combinations thereof.

The amount of solvent in the liquid crystal alignment agent is not specifically limited, but the solid content in the liquid crystal alignment agent may range from about 1 to about 30 wt %, for example, from about 3 to about 20 wt %. In some embodiments, the liquid crystal alignment agent may have a solid content of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the solid content of the liquid crystal alignment agent can be in a range from about any of the foregoing amounts to about any other of the foregoing amounts.

When the solid content is in an amount within the above range, the liquid crystal alignment agent may be less affected by impurities on a substrate surface during the printing process and may maintain an appropriate viscosity. This may prevent deterioration of the uniformity of the coating layer due to high viscosity and can provide appropriate transmittance during the printing process.

Other Additive(s)

The liquid crystal alignment agent according to one embodiment may further include one or more other additives.

The other additives may include an epoxy compound. The epoxy compound can improve reliability and electro-optical characteristics. The epoxy compound may include at least one kind of epoxy compound including 2 to 8 epoxy groups, for example, 2 to 4 epoxy groups.

Examples of the epoxy compound may include without limitation N,N,N′,N′-tetraglycidyl-4,4′-diaminophenylmethane (TGDDM), N,N,N′,N′-tetraglycidyl-4,4′-diaminophenylethane, N,N,N′,N′-tetraglycidyl-4,4′-diaminophenylpropane, N,N,N′,N′-tetraglycidyl-4,4′-diaminophenylbutane, N,N,N′,N′-tetraglycidyl-4,4′-diaminobenzene, ethyleneglycoldiglycidylether, polyethyleneglycoldiglycidylether, propyleneglycoldiglycidylether, tripropyleneglycoldiglycidylether, polypropyleneglycoldiglycidylether, neopentylglycoldiglycidylether, 1,6-hexanedioldiglycidylether, glycerinediglycidylether, 2,2-d ibromoneopentylg lycold iglycidylether, 1,3,5,6-tetraglycidyl-2,4-hexanediol, N,N,N′,N′-tetraglycidyl-1,4-phenylenediamine, N,N,N′,N′-tetraglycidyl-m-xylenediamine, N,N,N′,N′-tetraglycidyl-2,2′-dimethyl-4,4′-diaminobiphenyl, 2,2-bis[4-(N,N-diglycidyl-4-aminophenoxy)phenyl]propane, N,N,N′,N′-tetraglycidyl-4,4′-diaminodiphenylmethane, 1,3-bis(N,N-diglycidylaminomethyl)cyclohexane, 1,3-bis(N,N-diglycidylaminomethyl)benzene, and the like, and combinations thereof.

The liquid crystal alignment agent may include the epoxy compound in an amount of about 0.1 parts by weight to about 50 parts by weight, for example about 1 to about 30 parts by weight, based on about 100 parts by weight of the polymer. When the epoxy compound is included in an amount within the above range, it may provide appropriate printability and flatness during coating of a substrate and may easily improve reliability and electro-optical characteristics.

In order to improve printability, an additive such as an appropriate surfactant or a coupling agent may be further used.

The liquid crystal alignment film is fabricated by using the liquid crystal alignment agent.

The liquid crystal alignment film may be obtained by applying the liquid crystal alignment agent dissolved in an organic solvent on a substrate. Examples of methods of applying the liquid crystal alignment agent on the substrate may include without limitation spin coating, flexo printing, Inkjet printing and the like. Flexo printing may be generally used since it can provide excellent coating uniformity and can easily cover a wide area.

The substrate is not specifically limited as long as it has high transmittance. Examples of the substrate include without limitation glass substrates, plastic substrates such as acryl substrates and polycarbonate substrates, and the like. In addition, the substrate may include a substrate formed with an indium-tin oxide (ITO) electrode or the like for driving the liquid crystal to simplify manufacturing processes.

The liquid crystal alignment agent can be uniformly coated on the substrate to increase the coating uniformity and pre-dried at a temperature of about room temperature to about 200° C., for example, about 30° C. to about 150° C., or about 40° C. to about 120° C. for about 1 minute to about 100 minutes. The pre-drying process may promote control of the amount of volatilization of each component of the liquid crystal alignment agent to provide a uniform coating layer having minimal or no deviation.

Then, the coated substrate is baked at a temperature of about 80° C. to about 300° C., for example about 120° C. to about 280° C. for about 5 minutes to about 300 minutes to evaporate the solvent to provide a liquid crystal alignment film.

The obtained liquid crystal alignment film may be used for a liquid crystal display with uniaxial orientation by polarized ultraviolet (UV) irradiation or without uniaxial orientation for certain uses such as a vertical alignment layer and the like.

For example, the liquid crystal alignment film according to one embodiment may be subject to uniaxial orientation by exposing to radiation with energy in an amount of about 10 mJ to about 5,000 mJ for about 0.1 minute to about 180 minutes.

According to further another embodiment, a liquid crystal display is provided that includes the liquid crystal alignment film.

The liquid crystal display device (LCD) can include a 90 degree twisted liquid crystal between a polarizer and an analyzer which have polarized directions perpendicular to each other. When no voltage is applied, the linearly-polarized light passing through the polarizer is locally rotated according to the direction of other liquid crystal alignment body and deflected 90 degrees. Accordingly, the light is rotated and passed through an analyzer when passing through a liquid crystal layer. When applying voltage, since the liquid crystal is aligned in a direction parallel to the direction of an electric field, the linearly polarized light is passed through the liquid crystal layer without rotation, so it is blocked by the analyzer due to the perpendicularly polarized direction of analyzer, so not to be passed. In this manner, light may be selectively transmitted by controlling the liquid crystal, so it is very important to uniformly align the liquid crystal through the whole LCD panel in order to provide a uniform brightness and a high contrast ratio. Therefore, the liquid crystal alignment film may be usefully applied in this regard.

In addition, the liquid crystal display may be fabricated by, for example, a method of coating a liquid crystal alignment agent on a glass substrate on which a transparent indium tin oxide (ITO) conductive layer is deposited; thermally curing the same to provide an alignment layer; assembling two substrates to face each other; and injecting liquid crystal; or dripping liquid crystal on one substrate; and assembling the other substrate according to a liquid crystal drip method.

The following examples illustrate this disclosure in more detail. However, they are exemplary embodiments of this disclosure and are not limiting.

### EXAMPLES

### Comparative Example 1

### Preparation of polyamic acid (PSA-1)

0.5 mol of 4-(4,4,4-trifluoro butoxy)-benzoic acid 4-{2-[2-(2,4-diamino-phenyl)-ethoxycarbonyl]-vinyl}-phenyl ester represented by the following Chemical Formula 7 is introduced in a 4-necked flask including an agitator, a temperature controlling device, a nitrogen gas injection tube, and a cooler under dark room conditions while passing nitrogen therethrough, and N-methyl-2-pyrrolidone (NMP) is added and dissolved. 1.0 mol of a solid 4,10-dioxy-tricyclo[6.3.1.0^{2,7}]dodecane-3,5,9,11-tetraone is added thereto and vigorously agitated. After agitating for one hour, 0.5 mol of 4-(4,4,4-trifluoro butoxy)-benzoic acid 4-{2-[2-(2,4-diamino-phenyl)-ethoxycarbonyl]-vinyl}-phenyl ester represented by the following Chemical Formula 7 is added thereto and reacted until providing an appropriate viscosity. The solid content is 30 wt %, and it is reacted for 24 hours to provide a polyamic acid solution.

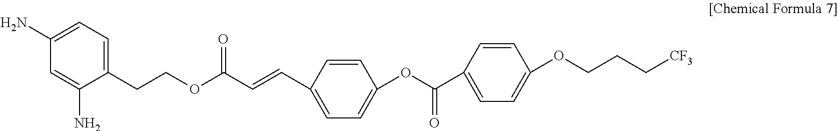

### Example 1

### Preparation of poly amic acid (PSA-2)

0.5 mol of 4-(4,4,4-trifluoro butoxy)-benzoic acid 4-{2-[2-(2,4-diamino-phenyl)-ethoxycarbonyl]-vinyl}-phenyl ester represented by Chemical Formula 7 is introduced in a 4-necked flask including an agitator, a temperature controlling device, a nitrogen gas injection tube, and a cooler under dark room conditions while passing nitrogen therethrough, and N-methyl-2-pyrrolidone (NMP) is added thereto and dissolved. 1.0 mol of a solid 4,10-dioxy-tricyclo[6.3.1.0^{2,7}]dodecane-3,5,9,11-tetraone is added thereto and vigorously agitated. After agitating for one hour, 0.3 mol of 4-(4,4,4-trifluoro butoxy)-benzoic acid 4-{2-[2-(2,4-diamino-phenyl)-ethoxycarbonyl]-vinyl}-phenyl ester represented by Chemical Formula 7 and 0.2 mol of (Z)-4-(3-(2,4-diaminophenethoxy)-3-oxoprop-1-enyl)phenyl 4-(4,4,4-trifluorobutoxy)benzoate represented by the following Chemical Formula 8 are added and reacted until providing an appropriate viscosity. The solid content is 30 wt %, and it is reacted for 24 hours to provide a polyamic acid solution.

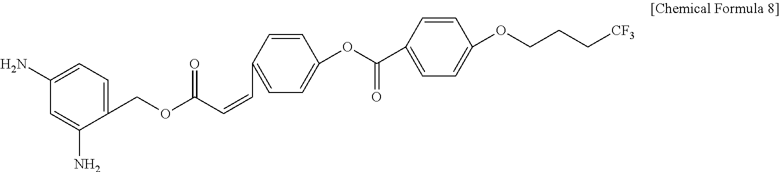

### Examples 2 to 5

### Preparation of polyamic acid (PSA-3 to 6)

Polyamic acid (PSA-3 to 6) solution is prepared in accordance with the same procedure as in Example 1, except that 4-(4,4,4-trifluoro butoxy)-benzoic acid 4-{2-[2-(2,4-diamino-phenyl)-ethoxycarbonyl]-vinyl}-phenyl ester (Chemical Formula 7) and (Z)-4-(3-(2,4-diaminophenethoxy)-3-oxo-prop-1-enyl)phenyl 4-(4,4,4-trifluorobutoxy)benzoate (Chemical Formula 8) are included in an amount shown in the following Table 1. The amount of 4-(4,4,4-trifluoro butoxy)-benzoic acid 4-{2-[2-(2,4-diamino-phenyl)-ethoxycarbonyl]-vinyl}-phenyl ester represented by Chemical Formula 7 shown in Table 1 is the total amount of the first amount and the second amount, and the first amount in all Examples is 0.5 mol.

### Comparative Example 2

### Preparation of polyimide (PSI-1)

0.5 mol of 4-(4,4,4-trifluoro butoxy)-benzoic acid 4-{2-[2-(2,4-diamino-phenyl)-ethoxycarbonyl]-vinyl}-phenyl ester represented by Chemical Formula 7 is introduced in a 4-necked flask including an agitator, a temperature controlling device, a nitrogen gas injection tube, and a cooler under dark room conditions while passing nitrogen therethrough, and N-methyl-2-pyrrolidone (NMP) is added and dissolved. 1.0 mol of a solid 4,10-dioxy-tricyclo[6.3.1.0^{2,7}]dodecane-3,5,9,11-tetraone is added thereto and vigorously agitated. After agitating for one hour, 0.5 mol of 4-(4,4,4-trifluoro butoxy)-benzoic acid 4-{2-[2-(2,4-diamino-phenyl)-ethoxycarbonyl]-vinyl}-phenyl ester represented by the following Chemical Formula 7 is added thereto and reacted until providing an appropriate viscosity. The solid content is 30 wt %, and it is reacted for 24 hours to provide a polyamic acid solution.

3.0 mol of acetic acid anhydride and 5.0 mol of pyridine are added to the polyamic acid solution and heated up to 80° C. and reacted for 6 hours, and the catalyst and the solvent are removed through vacuum distillation to provide a soluble polyimide resin having a solid content of 20%.

### Example 6

### Preparation of polyimide (PSI-2)

0.5 mol of 4-(4,4,4-trifluoro butoxy)-benzoic acid 4-{2-[2-(2,4-diamino-phenyl)-ethoxycarbonyl]-vinyl}-phenyl ester represented by the following Chemical Formula 7 is introduced in a 4-necked flask including an agitator, a temperature controlling device, a nitrogen gas injection tube, and a cooler under dark room conditions while passing nitrogen therethrough, and N-methyl-2-pyrrolidone (NMP) is added thereto and dissolved. 1.0 mol of a solid 4,10-dioxy-tricyclo[6.3.1.0^{2,7}]dodecane-3,5,9,11-tetraone is added thereto and vigorously agitated. After agitating for one hour, 0.3 mol of 4-(4,4,4-trifluoro butoxy)-benzoic acid 4-{2-[2-(2,4-diamino-phenyl)-ethoxycarbonyl]-vinyl}-phenyl ester represented by the following Chemical Formula 7 and 0.2 mol of (Z)-4-(3-(2,4-diaminophenethoxy)-3-oxo-prop-1-enyl)phenyl 4-(4,4,4-trifluorobutoxy)benzoate represented by Chemical Formula 8 are added thereto and reacted until providing an appropriate viscosity. The solid content is 30 wt %, and it is reacted for 24 hours to provide a polyamic acid solution.

3.0 mol of acetic acid anhydride and 5.0 mol of pyridine are added to the polyamic acid solution and heated up to 80° C. and reacted for 6 hours, and the catalyst and the solvent are removed through vacuum distillation to provide a soluble polyimide resin having a solid content of 20%.

### Examples 7 to 10

### Preparation of polyimide (PSI-3 to 6)

Polyamic acid (PSA-3 to 6) solution is prepared in accordance with the same procedure as in Example 1, except that 4-(4,4,4-trifluoro butoxy)-benzoic acid 4-{2-[2-(2,4-diamino-phenyl)-ethoxycarbonyl]-vinyl}-phenyl ester and (Z)-4-(3-(2,4-diaminophen ethoxy)-3-oxo-prop-1-enyl)phenyl 4-(4,4,4-trifluorobutoxy)benzoate are included in an amount shown in the following Table 1. The amount of 4-(4,4,4-trifluoro butoxy)-benzoic acid 4-{2-[2-(2,4-diamino-phenyl)-ethoxycarbonyl]-vinyl}-phenyl ester represented by Chemical Formula 7 shown in Table 1 is the total amount of the first amount and the second amount, and the first amount in all Examples is 0.5 mol.

TABLE 1

| | Preparation | Chemical | Chemical | |
|---|---|---|---|---|
| | Example | Formula 7 | Formula 8 | Type |
| Comparative | PSA-1 | 100 | — | polyamic acid |
| Example 1 | | | | |
| Example 1 | PSA-2 | 90 | 10 | polyamic acid |
| Example 2 | PSA-3 | 80 | 20 | polyamic acid |
| Example 3 | PSA-4 | 70 | 30 | polyamic acid |
| Example 4 | PSA-5 | 60 | 40 | polyamic acid |
| Example 5 | PSA-6 | 50 | 50 | polyamic acid |
| Comparative | PSI-1 | 100 | — | polyimide |
| Example 2 | | | | |
| Example 6 | PSI-2 | 90 | 10 | polyimide |
| Example 7 | PSI-3 | 80 | 20 | polyimide |
| Example 8 | PSI-4 | 70 | 30 | polyimide |
| Example 9 | PSI-5 | 60 | 40 | polyimide |
| Example 10 | PSI-6 | 50 | 50 | polyimide |

In Table 1, the amount units of the compound represented by Chemical Formula 7 and the compound represented by Chemical Formula 8 are mol % which is each amount mol % with respect to the total moles of dimaine used for preparing the polymer.

Confirmation of Cis and Trans Structure in Polymer Resin Through UV Analysis

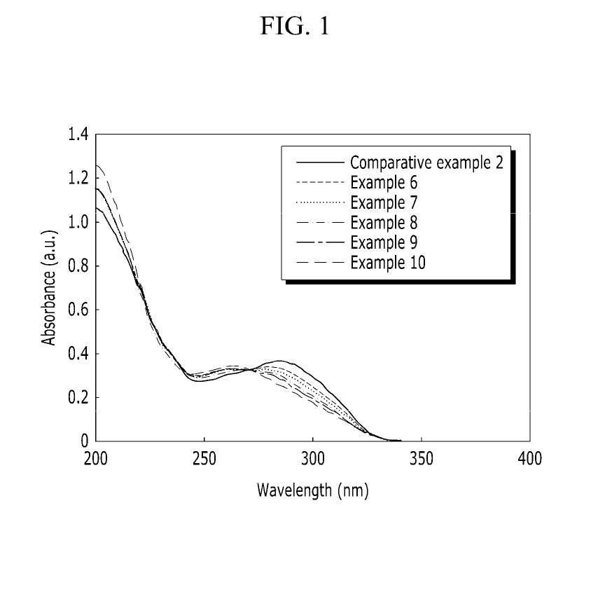

UV absorption is measured using polyimide resins obtained from the Examples 6 to 10 and Comparative Example 2 by a UVNIS spectrometer (V-550, JASCO), and the results are shown in FIG. 1. The carbon double bond in the diamine compound having cis structure represented by Chemical Formula 3 shows the maximum absorption peak around 262 nm; and the carbon double bond in the diamine compound having trans structure represented by Chemical Formula 4 shows the maximum absorption peak around 283 nm. From the results, it is understood that the polymers according to Examples 6 to 10 included all structures derived from diamine compounds having cis and trans structures.

<Evaluation of Physical Property>

Evaluation of Liquid Crystal Alignment Properties

A liquid crystal cell is used to evaluate vertical alignment properties of liquid crystal alignment agents. The liquid crystal cell is fabricated as follows.

A standardized indium-tin oxide (ITO) coated glass substrate is patterned by photolithography to remove indium-tin oxide (ITO) except for a 1.5 cm×1.5 cm square-shaped ITO and an ITO electrode shape for voltage application.

The liquid crystal alignment agents of Examples 1 to 10 and Comparative Examples 1 and 2 are spin-coated to a thickness of 0.1 μm on the patterned ITO substrate and cured at a temperature of 70° C. and 210° C.

The cured ITO substrate is exposed to a light under a predetermined angle and a predetermined energy by using an exposure device (UIS-S2021J7-YD01, Ushio LPUV). Two exposed substrates are bonded together by arranging the two exposed substrates in opposite exposure directions (VA mode, 90°) and maintaining a cell gap of 4.75 μm while aligning ITO square shapes at the top and bottom. The exposure is performed using a 2 kW deep UV lamp (UXM-2000) as a light source.

The obtained liquid crystal cell is filled with a liquid crystal. Liquid crystal alignment properties of each liquid crystal cell are measured by using a perpendicularly polarized optical microscope. A pretilt angle is measured using a crystal diffraction method (crystal rotation method). The results are shown in the following Table 2. The references for evaluating the liquid crystal alignment properties are follows:

<Reference for Evaluating Liquid Crystal Alignment Properties>

Good: no disinclination

Bad: disinclination

Voltage-Transmittance Evaluation of Liquid Crystal Alignment Film

The voltage-transmittance of the liquid crystal alignment films is measured using a liquid crystal cell with a 4.75 μm cell gap to evaluate electric characteristic. The results are provided in the following Table 2.

<Voltage-Transmittance Evaluation Reference>

Good: 99.0% or more

Middle: 98.5% or more and less than 99.0%

Bad: less than 98.5%

Processability Evaluation of Liquid Crystal Alignment Film

Each liquid crystal alignment agent obtained from Examples 1 to 10 and Comparative Examples 1 to 2 is printed on a glass substrate attached with a cleaned ITO by an alignment layer printer (CZ 200, Nakan) and allowed to stand on a hot plate at 80° C. for 90 seconds to pre-dry the alignment layer.

The pre-dried alignment layer substrate is baked on a hot plate at 220° C. for 15 minutes and exposed to energy of 10 mJ for 3 to 10 seconds to provide a substrate printed with an alignment layer.

The printability and thickness uniformity of the alignment layer of the substrate are measured along the whole surface of substrate by the naked eye and an electron microscope (MX50, Olympus), and the results are shown in the following Table 2.

<Processability Evaluation Reference>

Good: total defect of two or less, no stain, thickness deviation of less than 0.005 μm

Moderate: total defect of 5 or less, no stain, thickness deviation of less than 0.01 μm

Bad: total defect of more than 5 or stain found, or thickness deviation of more than 0.01 μm

Photo-Reactivity Evaluation of Liquid Crystal Alignment Film

The liquid crystal alignment agents according to Examples 1 to 10 and Comparative Examples 1 to 2, respectively, are applied to a cleaned quartz substrate and spin-coated to a thickness of 0.1 μm and then pre-dried on a 80° C. hot plate for 90 seconds.

The pre-dried alignment film substrate is baked on a 220° C. hot plate for 15 minutes and exposed to a light with an energy of 10 mJ for 3 to 10 seconds, to fabricate a substrate printed with a photo alignment film. The UV absorption of this substrate is measured. The UV absorption is analyzed with regard to structural change due to exposure in a Resier's method. The results are provided in Table 2.

<Photo-Reactivity Evaluation Reference>

4: photo-reaction rate of 25% or more

3: photo-reaction rate of 20% or more and less than 25%

2: photo-reaction rate of 10% or more and less than 20%

1: photo-reaction rate of less than 10%

TABLE 2

| | | | Voltage | | |
|---|---|---|---|---|---|
| | Preparation | Alignment | transmit- | Process- | Photo- |
| | Example | properties | tance | ibility | reactivity |
| Comparative | PSA-1 | Good | Middle | Good | 1 |
| Example 1 | | | | | |
| Example 1 | PSA-2 | Good | Good | Good | 3 |
| Example 2 | PSA-3 | Good | Good | Good | 4 |
| Example 3 | PSA-4 | Good | Good | Good | 4 |
| Example 4 | PSA-5 | Good | Good | Good | 4 |
| Example 5 | PSA-6 | Good | Middle | Good | 3 |
| Comparative | PSI-1 | Good | Middle | Good | 1 |
| Example 2 | | | | | |
| Example 6 | PSI-2 | Good | Good | Good | 3 |
| Example 7 | PSI-3 | Good | Good | Good | 4 |
| Example 8 | PSI-4 | Good | Good | Good | 4 |
| Example 9 | PSI-5 | Good | Good | Good | 4 |
| Example 10 | PSI-6 | Good | Middle | Good | 2 |

### Examples 1 to 10 showed superior results of photo-reactivity compared to Comparative Examples 1 and 2

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A liquid crystal alignment agent comprising:
a polymer comprising polyamic acid including a structural unit represented by the following Chemical Formula 1, polyimide including a structural unit represented by the following Chemical Formula 2, or a combination thereof: 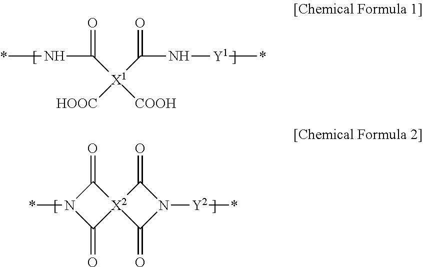
wherein, in Chemical Formulas 1 and 2,
X¹ and X² are the same or different and are each independently a tetravalent organic group derived from alicyclic acid dianhydride or aromatic acid dianhydride, and
Y¹ and Y² are the same or different and are each independently a divalent organic group derived from diamine, wherein the diamine includes a diamine represented by the following Chemical Formula 3 and a diamine represented by the following Chemical Formula 4, 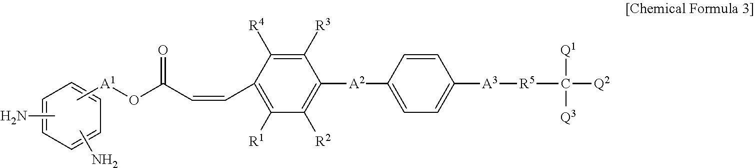
wherein, in Chemical Formula 3,
A¹ is a single bond or C1 to C2 alkylene,
A² is substituted or unsubstituted C1 to C30 alkylene or C1 to C30 alkylene wherein at least one —CH₂— group thereof is independently replaced by —O—, —O(O)C—, —C(O)O—, —OC(O)O—, —N(H)C(O)—, —C(O)N(H)—, or —C(O)—,
A³ is a single bond, O, SO₂, or C(R¹⁰³)(R¹⁰⁴), wherein R¹⁰³ and R¹⁰⁴ are the same or different and are independently hydrogen or substituted or unsubstituted C1 to C6 alkyl,
R¹ to R⁴ are the same or different and are independently hydrogen, substituted or unsubstituted C1 to C30 alkyl, substituted or unsubstituted C6 to C30 aryl, or substituted or unsubstituted C2 to C30 heteroaryl,
R⁵ is substituted or unsubstituted C1 to C30 alkylene or C1 to C30 alkylene wherein at least one —CH₂— group thereof is independently replaced by —C(O)—, —C(O)O—, —N(W)—, —N(W)C(O)—, —C(O)N(W)— or —CH═CH—, wherein W is hydrogen or C1 to C10 alkyl, with the proviso that oxygen atoms are not directly linked to each other, and
Q¹, Q² and Q³ is each independently hydrogen or halogen, 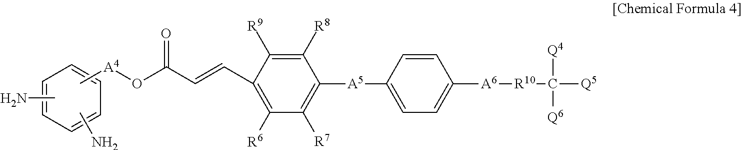
wherein, in Chemical Formula 4,
A⁴ is a single bond or C1 to C2 alkylene,
A⁵ is substituted or unsubstituted C1 to C30 alkylene or C1 to C30 alkylene wherein at least one —CH₂— group thereof is independently replaced by —O—, —OC(O)—, —C(O)O—, —OC(O)O—, —N(H)C(O)—, —C(O)N(H)—, or —C(O)—,
A⁶ is a single bond, O, SO₂ or C(R¹⁰⁵)(R¹⁰⁶), wherein R¹⁰⁵ and R¹⁰⁶ are the same or different and are independently hydrogen or substituted or unsubstituted C1 to C6 alkyl,
R⁶ to R⁹ are the same or different and are independently hydrogen, substituted or unsubstituted C1 to C30 alkyl, substituted or unsubstituted C6 to C30 aryl, or substituted or unsubstituted C2 to C30 heteroaryl,
R¹⁰ is substituted or unsubstituted C1 to C30 alkylene or C1 to C30 alkylene wherein at least one —CH₂— group thereof is independently replaced by —C(O)—, —C(O)O—, —N(Z′)—, —N(Z′)C(O)—, —C(O)N(Z′)—, or —CH═CH—, wherein Z′ is hydrogen or C1 to C10 alkyl, with the proviso that oxygen atoms are not directly linked to each other, and
Q⁴, Q⁵ and Q⁶ is each independently hydrogen or halogen.

2. The liquid crystal alignment agent of claim 1, wherein the diamine comprises about 10 mol % to about 90 mol % of the diamine represented by the above Chemical Formula 3 and about 10 mol % to about 90 mol % of the diamine represented by the above Chemical Formula 4, based on the total amount of diamine.

3. The liquid crystal alignment agent of claim 1, wherein the diamine represented by the above Chemical Formula 3 comprises the diamine represented by the following Chemical Formula 5: 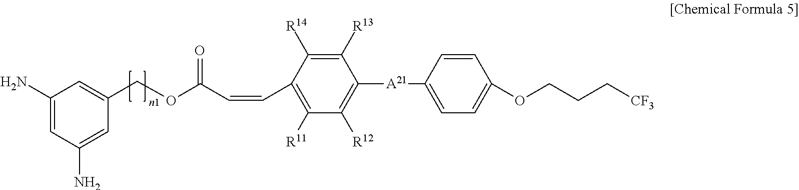
wherein, in Chemical Formula 5,
A²¹ is —O—, —OC(O)—, or —C(O)O—,
R¹¹ to R¹⁴ are each independently hydrogen or substituted or unsubstituted C1 to C10 alkyl, and
n1 is an integer ranging from 0 to 2.

4. The liquid crystal alignment agent of claim 1, wherein the diamine represented by the above Chemical Formula 4 comprises the diamine represented by the following Chemical Formula 6: 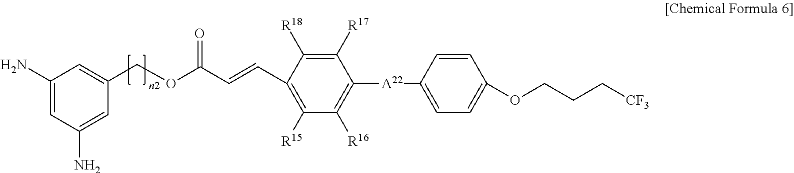
wherein, in Chemical Formula 6,
A²² is —O—, —OC(O)—, or —C(O)O—,
R¹⁵ to R¹⁸ are each independently hydrogen or substituted or unsubstituted C1 to C10 alkyl, and
n2 is an integer ranging from 0 to 2.

5. The liquid crystal alignment agent of claim 1, wherein each of the polyamic acid and the polyimide has a weight average molecular weight of about 50,000 to about 500,000.

6. The liquid crystal alignment agent of claim 1, wherein when the liquid crystal alignment agent comprises both of the polyamic acid and the polyimide, the polyamic acid and the polyimide are included at a weight ratio of about 1:99 to about 50:50.

7. The liquid crystal alignment agent of claim 1, comprising a solid content of about 1 wt % to about 30 wt %.

8. A liquid crystal alignment film manufactured by applying the liquid crystal alignment agent of claim 1 to a substrate

9. A liquid crystal display including the liquid crystal alignment film of claim 8.
